(19) United States
(12) Patent Application Publication
(10) Pub. No.: US 2014/0234701 A1
(43) Pub. Date: Aug. 21, 2014

(54) NON-AQUEOUS ELECTROLYTE SECONDARY BATTERY

(71) Applicant: SANYO Electric Co., Ltd., Moriguchi-shi, Osaka (JP)

(72) Inventors: Tadayoshi Tanaka, Osaka (JP); Takatoshi Higuchi, Hyogo (JP); Kazunari Ohkita, Osaka (JP); Katsunori Yanagida, Hyogo (JP); Yoshinori Kida, Hyogo (JP)

(73) Assignee: SANYO ELECTRIC CO., LTD., Moriguchi-shi, Osaka (JP)

(21) Appl. No.: 14/347,430

(22) PCT Filed: Sep. 20, 2012
(86) PCT No.: PCT/JP2012/073981

§ 371 Date: Mar. 26, 2014

(30) Foreign Application Priority Data
Sep. 28, 2011 (JP) 2011-212016

(51) Int. Cl. H01M 10/052; H01M 4/505; H01M 4/525; H01M 10/0568

(52) U.S. Cl. CPC H01M 10/052; H01M 10/0568; H01M 4/505; H01M 4/525; H01M 2300/0025; H01M 2220/30
USPC 429/199

(57) ABSTRACT

The object is to provide a nonaqueous electrolyte secondary battery which can improve performance (increase in capacity) and reduce cost by improvement in heat stability. There are provided a positive electrode including a metal halide and a positive electrode active material containing a lithium transition metal oxide which includes nickel and manganese, a negative electrode including a negative electrode active material, and a nonaqueous electrolyte including a nonaqueous solvent, a fluorine-containing lithium salt, and a lithium salt which includes an oxalate complex as an anion.

### TECHNICAL FIELD

The present invention relates to a nonaqueous electrolyte secondary battery.

### BACKGROUND ART

In recent years, the reduction in size and weight of mobile apparatuses, such as a mobile phone and a notebook personal computer, has been significantly advanced, and in addition, the consumption power thereof has also been increased in concomitant with an increase in function of the apparatuses. Accordingly, nonaqueous electrolyte secondary batteries which are used as power sources of the mobile apparatuses described above are also increasingly desired to satisfy the reduction in weight and the increase in capacity.

In addition, in order to overcome an environmental problem caused by exhaust gases ejected from vehicles, recently, development of hybrid type electric automobiles, in each of which a gasoline engine of an automobile and an electric motor are mounted in combination, has been progressively carried out. In addition, as a power source for the application as described above, although a nickel-hydrogen storage battery has been widely used in general, as a power source having a higher capacity and a higher output, the use of a nonaqueous electrolyte secondary battery has been investigated. As a positive electrode active material for this nonaqueous electrolyte secondary battery, a lithium transition metal oxide, such as lithium cobalate (LiCoO₂), containing cobalt as a primary component has been mainly used.

However, since cobalt used for the above positive electrode active material is a rare resource, besides an increase in cost, for example, a problem may arise in that stable supply is difficult to maintain, and in particular, when the nonaqueous electrolyte secondary battery is used as a power source of a hybrid type electric automobile, a large amount of cobalt is required, and as a result, the cost of the power source will be remarkably increased.

In addition, in the nonaqueous electrolyte secondary battery described above, improvement in performance and increase in life have been further desired, and in association with the improvement in performance as described above, it becomes important to secure the safety.

In consideration of those described above, the following proposals have been made.

(1) The proposal in which as a positive electrode active material, a lithium transition metal oxide represented by LiₐM_{b}Ni_{c}Co_{d}Oₑ is used (however, M represents at least one type of metal selected from the group consisting of Al, Mn, Sn, In, Fe, Cu, Mg, Ti, Zn, and Mo; 0<a<1.3, 0.02≦b≦0.5, 0.02≦d/c+d≦0.9, and 1.8<e<2.2 are satisfied; and furthermore, b+c+d=1 and 0.34<c are satisfied) (see Patent Document 1 described below).

(2) The proposal in which the surfaces of lithium transition metal oxide particles each functioning as a positive electrode active material are covered with a lithium compound (see Patent Document 2 described below).

(3) The proposal in which a lithium salt including an oxalate complex as an anion is added to a nonaqueous electrolyte of a battery using a lithium transition metal oxide as a positive electrode active material (see Patent Document 3 described below).

### CITATION LIST

### Patent Document

PTD 1: Japanese Patent No. 3244314
PTD 2: Japanese Published Unexamined Patent Application No. 2006-318815
PTD 3: Japanese Published Unexamined Patent Application No. 2006-196250

### SUMMARY OF INVENTION

### Technical Problem

However, since a heat stability at a positive electrode is insufficient even by the proposals described above, the battery temperature may be increased in some cases. Hence, a design change of the battery, such as to set a charging potential to be low, is required, and as a result, improvement in performance (increase in capacity) of the battery may not be performed. On the other hand, in consideration of the case in which the battery temperature is increased, it may also be considered to additionally provide a battery safety mechanism; however, in this case, there may be a problem in that the cost of the battery and that of an apparatus using the same is increased.

### Solution to Problem

The present invention comprises: a positive electrode including a metal halide and a positive electrode active material containing a lithium transition metal oxide which includes nickel and manganese; a negative electrode including a negative electrode active material; and a nonaqueous electrolyte including a nonaqueous solvent, a fluorine-containing lithium salt, and a lithium salt which includes an oxalate complex as an anion.

### Advantageous Effects of Invention

According to the present invention, an excellent effect of improving the heat stability of the battery can be obtained.

### DESCRIPTION OF EMBODIMENTS

The present invention comprises: a positive electrode including a metal halide and a positive electrode active material containing a lithium transition metal oxide which includes nickel and manganese; a negative electrode including a negative electrode active material; and a nonaqueous electrolyte including a nonaqueous solvent, a fluorine-containing lithium salt, and a lithium salt which includes an oxalate complex as an anion.

According to the above configuration, the heat stability of a nonaqueous electrolyte secondary battery is improved. Hence, since a design change of the battery, such as to set a charging potential to be low, is not required, the improvement in performance (increase in capacity) of the battery can be performed, and in addition, since an additional safety mechanism of the battery is also not required, the cost of the battery and that of an apparatus using the same may be reduced.

In this case, it is believed that the heat stability of the nonaqueous electrolyte secondary battery is improved by the following reasons.

When the temperature of the nonaqueous electrolyte secondary battery is increased (to 200° C. or more in general), the fluorine-containing lithium salt is decomposed by heat, and lithium fluoride is generated (for example, when LiPF₆ is used as the fluorine-containing lithium salt, LiPF₆ is decomposed into LiF and PF₅). In this case, when a metal halide is added to the positive electrode as in the configuration described above, lithium fluoride generated by the above heat decomposition is likely to precipitate in the positive electrode, and the surface of the positive electrode active material is covered with lithium fluoride. As a result, since the transition metal in the positive electrode active material is suppressed from being brought into contact with the nonaqueous electrolyte, the oxidation thereof can be suppressed.

In addition, when the nonaqueous electrolyte and the negative electrode are directly brought into contact with each other under a high-temperature environment, a reaction product is generated and then moves toward the positive electrode, so that an oxidation reaction in the nonaqueous electrolyte on the surface of the positive electrode is promoted. However, when a lithium salt including an oxalate complex as an anion is included in the nonaqueous electrolyte, the lithium salt is reduced at the negative electrode, and a coat is formed on the surface of the negative electrode active material. Hence, since the nonaqueous electrolyte and the negative electrode can be suppressed from being directly brought into contact with each other, the amount of the reaction product is decreased even under a high-temperature environment. As a result, the oxidation of the nonaqueous electrolyte on the surface of the positive electrode caused by the movement of the reaction product toward the positive electrode can be further suppressed.

In this embodiment, the reasons the positive electrode active material is limited to a lithium transition metal oxide which includes nickel and manganese are as described below.

When a lithium transition metal oxide (LiNiO₂) including only nickel is used as the positive electrode active material, the heat stability of LiNiO₂ is extremely low. Hence, compared to oxidation of the nonaqueous electrolyte on the surface of the positive electrode active material caused by a catalytic action thereof, oxidation of the nonaqueous electrolyte caused by oxygen desorption from the positive electrode active material becomes significantly dominant. Accordingly, even when a metal halide is added, and the surface of the positive electrode active material is covered with lithium fluoride, the oxidation of the nonaqueous electrolyte may not be sufficiently suppressed, and hence, the heat generation may not be suppressed. On the other hand, when a lithium transition metal oxide including manganese besides nickel is used as the positive electrode active material, the heat stability is improved as compared to that of the above LiNiO₂. As a result, compared to the oxidation of the nonaqueous electrolyte caused by oxygen desorption from the positive electrode active material, the oxidation of the nonaqueous electrolyte on the surface of the positive electrode active material caused by a catalytic action thereof becomes significantly dominant. Hence, it is believed that when the surface of the positive electrode active material is covered with lithium fluoride, the oxidation of the nonaqueous electrolyte can be suppressed.

In addition, as the positive electrode active material, when a lithium transition metal oxide including cobalt besides nickel and manganese is used, the operation and effect of the present invention may also be obtained. However, when a lithium transition metal oxide (LiCoO₂) including only cobalt is used as the positive electrode active material, the operation and effect of the present invention may not be obtained. The reason for this is that since the oxidation reaction of the nonaqueous electrolyte caused by a catalytic action of LiCoO₂ is hard to be extremely caused, although the positive electrode active material and the nonaqueous electrolyte are suppressed from being brought into contact with each other by covering the surface of the positive electrode active material with lithium fluoride, the suppression in oxidation thereby has not significant meaning.

As the lithium transition metal oxide described above, an oxide having a layered structure and represented by the general formula of Li₁₊ₓNiₐMn_{b}Co_{c}O_{2+d} is preferably used (in the formula, x, a, b, c, and d satisfy x+a+b+c=1, 0.7≦a+b, 0<x≦0.1, 0≦c/(a+b)<0.65, 0.7≦a/b≦2.0, and −0.1≦d≦0.1).

In the lithium transition metal oxide represented by the above general formula, the reason an oxide is used in which the composition ratio c of cobalt, the composition ratio a of nickel, and the composition ratio b of manganese satisfy 0≦c/(a+b)<0.65 is that the ratio of cobalt is decreased so as to reduce a material cost of the positive electrode active material.

In addition, in the lithium transition metal oxide represented by the above general formula, the reasons an oxide is used in which the composition ratio a of nickel and the composition ratio b of manganese satisfy 0.7≦a/b≦2.0 are as described below. That is, when the ratio of nickel is increased so that the value of a/b is more than 2.0, since the heat stability of this lithium transition metal oxide is degraded, the temperature at which the amount of heat generation is peaked is decreased, and as a result, the safety may be degraded in some cases. On the other hand, when the value of a/b is less than 0.7, since the ratio of manganese is increased, an impurity layer is generated, and as a result, the positive electrode capacity is decreased.

Furthermore, in the lithium transition metal oxide represented by the above general formula, the reasons an oxide is used in which x of the composition ratio (1+x) of lithium satisfies the condition of 0<x≦0.1 are as described below. That is, when x>0 is satisfied, the output performance is improved, and on the other hand, when x>0.1 is satisfied, since the amount of an alkali remaining on the surface of this lithium transition metal oxide is increased, a slurry is gelled in a battery manufacturing process, and at the same time, since the amount of the transition metal which performs an oxidation-reduction reaction is decreased, the positive electrode capacity is decreased. In addition, x more preferably satisfies the condition of 0.05≦x≦0.1.

In addition, in the lithium transition metal oxide represented by the above general formula, the reason d of the composition ratio (2+d) of oxygen is set to satisfy the condition of −0.1≦d≦0.1 is to prevent the crystalline structure of the lithium transition metal oxide from being damaged in an oxygen deficient state or in an oxygen excessive state.

The lithium salt including an oxalate complex is lithium bisoxalate borate, and the concentration thereof to the above nonaqueous solvent is preferably 0.05 mol/liter or more and 0.3 mol/liter or less.

The reasons for this are that when the concentration is less than 0.05 mol/liter, the effect obtained by the addition of lithium bisoxalate borate may be insufficient in some cases, and that when the concentration is more than 0.3 mol/liter, the discharge capacity of the battery is decreased.

A halogen of the above metal halide is preferably fluorine or chlorine, and a metal is preferably lithium (Li), sodium (Na), magnesium (Mg), calcium (Ca), or zirconium (Zr). In particular, the above metal halide is preferably at least one type selected from the group consisting of LiF, NaF, MgF₂, CaF₂, ZrF₄, LiCl, NaCl, MgCl₂, CaCl₂, and ZrCl₄. That is, as the metal halide, instead of using only one compound, such as LiF, for example, LiF and LiCl may also be used in combination.

In addition, the metal halide is not limited to the above LiF or the like, and for example, a chloride, a fluoride, a bromide, and an iodide, each of which is formed of aluminum (Al), titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), tantalum (Ta), tin (Sn), tungsten (W), potassium (K), barium (Ba), or strontium (Sr), may also be used, and furthermore, a bromide and an iodide of the above-described Li, Na, Mg, Ca, or Zr may also be used.

The rate of the metal halide to the above positive electrode active material is preferably 0.1 percent by mass or more and 5.0 percent by mass or less.

The reasons for this are that when the above rate is less than 0.1 percent by mass, the effect obtained by the addition of the metal halide may be insufficient in some cases, and on the other hand, when the above rate is more than 5.0 percent by mass, since the positive electrode active material is decreased in an amount corresponding to that of the metal halide, the positive electrode capacity is decreased.

(Other Items)

(1) The lithium salt including an oxalate complex as an anion described above is not limited to LiBOB (lithium bisoxalate borate) shown in Examples which will be described later, and there may be used a lithium salt including an anion in which C₂O₄⁻² is coordinated to a central atom, such as Li[M(C₂O₄)ₓR_{y}] (in the formula, M represents an element selected from a transition metal and one of a group IIIb, a group IVb, and a group vb element of the period table; R represents a group selected from a halogen, an alkyl group, and a halogenated alkyl group; x is a positive integer; and y is 0 or a positive integer). In particular, for example, Li[B(C₂O₄)F₂], Li[P(C₂O₄)F₄], and Li[P(C₂O₄)₂F₂] may be mentioned. However, in order to form a stable coat on a surface of the negative electrode even under a high-temperature environment, LiBOB is most preferably used.

(2) As the above fluorine-containing lithium salt, for example, there may be mentioned LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, and LiAsF₆. In addition, as the electrolyte salt, there may also be used a salt formed by adding to a fluorine-containing lithium salt, a lithium salt [lithium salt (such as LiClO₄) containing at least one type of P, B, O, S, N, and Cl] other than the fluorine-containing lithium salt.

(3) In the above lithium transition metal oxide, a least one type selected from the group consisting of boron (B), fluorine (F), magnesium (Mg), aluminum (Al), titanium (Ti), chromium (Cr), vanadium (V), iron (Fe), copper (Cu), zinc (Zn), niobium (Nb), molybdenum (Mo), tantalum (Ta), zirconium (Zr), tin (Sn), tungsten (W), sodium (Na), potassium (K), barium (Ba), strontium (Sr), and calcium (Ca) may also be included.

(4) The above negative electrode active material is not particularly limited as long as being capable of reversibly occluding and releasing lithium, and for example, a carbon material, a metal or an alloy material, each of which forms an alloy with lithium, and a metal oxide may be used. In addition, in view of the material cost, a carbon material is preferably used for the negative electrode active material, and for example, natural graphite, artificial graphite, mesophase pitch-based carbon fibers (MCF), mesocarbon microbeads (MCMB), cokes, hard carbon, fullerene, and carbon nanotubes may be used. In particular, in order to improve a high rate charge discharge characteristics, a carbon material formed by covering a graphite material with low-crystalline carbon is preferably used.

(5) As the nonaqueous solvent used for the above nonaqueous electrolyte, a known solvent which has been used may be used, and for example, a cyclic carbonate, such as ethylene carbonate, propylene carbonate, butylene carbonate, or vinylene carbonate, or a chain carbonate, such as dimethyl carbonate, methyl ethyl carbonate, or diethyl carbonate, may be used. In particular, as a nonaqueous solvent having a low viscosity, a low melting point, and a high lithium ion conductivity, a mixed solvent of a cyclic carbonate and a chain carbonate is preferably used. In addition, the volume ratio of a cyclic carbonate and a chain carbonate of this mixed solvent is preferably set in a range of 2:8 to 5:5.

Furthermore, as the nonaqueous solvent of the nonaqueous electrolyte, an ionic liquid may also be used, and in this case, a cationic species and an anionic species are not particularly limited. However, in consideration of a low viscosity, an electrochemical stability, and a hydrophobic characteristic, a pyridium cation, an imidazolium cation, or a quaternary ammonium cation, which functions as the cation, and a fluorine-containing imide-based anion, which functions as the anion, are particularly preferably used in combination.

(6) A separator used in the nonaqueous electrolyte secondary battery of the present invention is not particularly limited as long as a short circuit caused by the contact between the negative electrode and the positive electrode can be suppressed, and a lithium ionic conductivity can be obtained when the separator is impregnated with a nonaqueous electrolyte. For example, a polypropylene-made or a polyethylene-made separator, or a polypropylene-polyethylene multilayer separator may be used.

### EXAMPLES

Hereinafter, although the present invention will be described in more detail with reference to Examples, the present invention is not limited at all thereto and may be appropriately changed and modified without departing from the scope of the present invention.

### First Example

### Example

### [Formation of Positive Electrode]

First, after Li₂Co₃ was mixed at a predetermined ratio with [Ni_{0.35}Mn_{0.30}Co_{0.35}](OH)₂ formed by a co-precipitation method, firing was performed at 900° C. for 10 hours in the air, so that Li_{1.06}[Ni_{0.33}Mn_{0.28}Co_{0.33}]O₂ was formed as the positive electrode active material. The average particle diameter of the positive electrode active material was approximately 12 μm. Next, the positive electrode active material, lithium fluoride, carbon black functioning as a conductive agent, and an N-Methyl-2-Pyrrolidone solution in which a poly(vinylidene fluoride) was dissolved as a binder agent were weighted so that the mass ratio of the positive electrode active material, the lithium fluoride, the conductive agent, and the binder agent was 91:1:5:3 and were then kneaded together, so that a positive electrode mixture slurry was prepared. Accordingly, the rate of the lithium fluoride to the positive electrode active material was set to 1.1 percent by mass.

Next, after the positive electrode mixture slurry was applied to two facing surfaces of a positive electrode collector formed of aluminum foil and was then dried, rolling thereof was performed using rolling rollers, and an aluminum collector tab was fitted to the rolled collector to form the positive electrode. In addition, the average particle diameter of the positive electrode active material is a median value obtained by particle distribution measurement using a laser diffraction method. In addition, in the following examples, the average particle diameter was also measured by a method similar to that described above.

[Formation of Negative Electrode]

First, after a graphite powder functioning as the negative electrode active material was charged into a solution in which CMC (carboxy methyl cellulose) functioning as a thickening agent was dissolved in water and was then stirred, an SBR (styrene butadiene rubber) functioning as a binder was mixed with the above solution, so that a negative electrode mixture slurry was prepared. In addition, when the negative electrode mixture slurry was prepared, the mass ratio of the graphite, CMC, and SBR was set to 98:1:1. Next, after the negative electrode mixture slurry was applied to two facing surfaces of a negative electrode collector formed of copper foil and was then dried, rolling thereof was performed using rolling rollers, and a nickel collector tab was fitted to the rolled collector to form the negative electrode.

[Preparation of Nonaqueous Electrolyte]

In a solvent in which ethylene carbonate (EC), methyl ethyl carbonate (MEC), and dimethyl carbonate (DMC) were mixed together to have a volume ratio of 3:3:4, LiPF₆ functioning as an electrolyte salt (fluorine-containing lithium salt) was dissolved to have a concentration of 1 mol/liter, and vinylene carbonate was further dissolved at a rate of 1 percent by mass. Subsequently, LiBOB [lithium bisoxalate borate] functioning as a lithium salt in which an oxalate complex was used as an anion was dissolved to have a concentration of 0.1 mol/liter, thereby preparing a nonaqueous electrolyte.

[Formation of Nonaqueous Electrolyte Secondary Battery]

A polyethylene-made separator was disposed between the positive electrode and the negative electrode thus formed and was then spirally wound to form a spiral-shaped electrode body. Next, after this electrode body was received in an aluminum laminate-made exterior package, and the nonaqueous electrolyte was further charged into the exterior package, the exterior package was sealed, so that a nonaqueous electrolyte secondary battery (theoretical capacity: 16 mAh) was formed.

Hereinafter, the battery formed as described above is called the “battery A”.

### Comparative Example 1

Except that lithium fluoride was not added in the positive electrode formation, and LiBOB was not added to the nonaqueous electrolyte, a battery was formed in a manner similar to that in the above Example 1. In addition, in the positive electrode formation, the ratio of the positive electrode active material, the conductive agent, and the binder agent was set to 92:5:3 on a mass ratio.

Hereinafter, the battery formed as described above is called the “battery Z1”.

### Comparative Example 2

Except that instead of using lithium fluoride, lithium carbonate was added in the positive electrode formation, and LiBOB was not added to the nonaqueous electrolyte, a battery was formed in a manner similar to that in the above Example 1. In addition, in the positive electrode formation, the ratio of the positive electrode active material, the lithium carbonate, the conductive agent, and the binder agent was set to 91:1:5:3 on a mass ratio.

Hereinafter, the battery formed as described above is called the “battery Z2”.

### Comparative Example 3

Except that instead of using lithium fluoride, lithium phosphate was added in the positive electrode formation, and LiBOB was not added to the nonaqueous electrolyte, a battery was formed in a manner similar to that in the above Example 1. In addition, in the positive electrode formation, the ratio of the positive electrode active material, the lithium phosphate, the conductive agent, and the binder agent was set to 91:1:5:3 on a mass ratio.

Hereinafter, the battery formed as described above is called the “battery Z3”.

### Comparative Example 4

Except that LiBOB was not added to the nonaqueous electrolyte, a battery was formed in a manner similar to that in the above Example 1.

Hereinafter, the battery formed as described above is called the “battery Z4”.

### Comparative Example 5

Except that lithium fluoride was not added in the positive electrode formation, a battery was formed in a manner similar to that in the above Example 1. In addition, in the positive electrode formation, the ratio of the positive electrode active material, the conductive agent, and the binder agent was set to 92:5:3 on a mass ratio.

Hereinafter, the battery formed as described above is called the “battery Z5”.

### Experiment

After the above batteries A and Z1 to Z5 were each charged and discharged under the following conditions, and each laminate was opened in a fully charged state, the electrode body was recovered and then received in a pressure-resistant container for calorimetric measurement, and the temperature was increased from 30° C. to 300° C. at a temperature rise rate of 1.0° C./min. In this case, the amount of heat generation from 160° C. to 240° C. was measured using a calorimeter (calorimetry-C80 manufactured by Setaram), and the results are shown in Table 1. In addition, the amount of heat generation of each battery is shown by the index based on the assumption in which the amount of heat generation of the battery Z1 is 100.

Charge Discharge Conditions

A charge discharge cycle was performed twice in each of which after constant current charging was performed at a charge current of (¼)It until a battery voltage reached 4.1 V, and constant voltage charging was then performed at a battery voltage of 4.1 V until a charge current reached ( 1/20)It, charging was rested for 15 minutes, and discharging was then performed at a current of (¼)It until the battery voltage reached 2.5 V. Subsequently, constant current charging was performed at a charge current of (¼)It until the battery voltage reached 4.1 V, and constant voltage charging was performed at a battery voltage of 4.1 V until the charge current reached ( 1/20)It. Those described above were the charge discharge conditions.

TABLE 1

| | | | | Amount of |
|---|---|---|---|---|
| | Positive Electrode Active | Positive Electrode | Electrolyte | Heat |
| Battery | Material | Additive | Additive | Generation |
| A | Li_{1.06}[Ni_{0.33}Mn_{0.28}Co_{0.33}]O₂ | Lithium fluoride | LiBOB | 86 |
| Z1 | | None | None | 100 |
| Z2 | | Lithium carbonate | | 99 |
| Z3 | | Lithium phosphate | | 99 |
| Z4 | | Lithium fluoride | | 92 |
| Z5 | | None | LiBOB | 99 |

As apparent from the above Table 1, when the batteries Z1 to Z4, in each of which LiBOB was not added to the electrolyte, are compared to each other, the amount of heat generation of the battery Z4 in which lithium fluoride was added to the positive electrode was decreased as compared to that of the battery Z1 in which lithium fluoride was not added to the positive electrode, and hence, it was found that the heat stability was improved. On the other hand, it was found that in the batteries Z2 and Z3 in which although being added to the positive electrodes, the lithium compounds were lithium carbonate and lithium phosphate, respectively, the amount of heat generation was hardly decreased as compared to that of the above Z1. From the results described above, as the lithium compound added to the positive electrode, lithium fluoride is required instead of lithium carbonate and lithium phosphate. Although the reason for this has not been clearly understood, when LiPF₆ functioning as an electrolyte salt is decomposed into LiF and PF₅ by heat, in the positive electrode containing lithium fluoride, LiF is likely to precipitate on the surface of the positive electrode active material. Hence, the surface of the positive electrode active material is covered with LiF, and the contact between the transition metal in the positive electrode active material and the nonaqueous electrolyte is prevented. As a result, it is believed that since the oxidation of the nonaqueous electrolyte is suppressed, the amount of heat generation is decreased.

On the other hand, when the battery Z1 and the battery Z5, in each of which the lithium compound was not added to the positive electrode, are compared to each other, it is found that the amount of heat generation of the battery Z5 in which LiBOB was added to the electrolyte was hardly decreased as compared to that of the battery Z1 in which LiBOB was not added to the positive electrode. However, it was found that in the battery A in which lithium fluoride was added to the positive electrode, and the LiBOB was added to the electrolyte, the amount of heat generation was further suppressed as compared to that of the battery Z4 in which although lithium fluoride was added to the positive electrode, LiBOB was not added to the electrolyte. The reason for this is that when lithium fluoride was added to the positive electrode, and LiBOB was contained in the electrolyte, by reduction of LiBOB at the negative electrode, a coat was formed on the surface of the negative electrode active material. Hence, since the direct contact between the nonaqueous electrolyte and the negative electrode can be suppressed, even under a high-temperature environment, the amount of a reaction product is decreased. As a result, it is believed that the oxidation of the nonaqueous electrolyte at the surface of the positive electrode caused by the movement of the reaction product toward the positive electrode can be further suppressed.

From the results described above, it is found that in order to obtain the effect of the present invention, the addition of lithium fluoride to the positive electrode and the addition of LiBOB to the electrolyte are required.

### Second Example

### Example 1

Except that the positive electrode active material was formed as described below, a battery was formed in a manner similar to that in Example of the first example.

Hereinafter, the battery thus formed is called the “battery B1”.

After Li₂Co₃ was mixed at a predetermined ratio with [Ni_{0.5}Mn_{0.3}Co_{0.2}](OH)₂ formed by a co-precipitation method, firing was performed at 930° C. for 10 hours in the air, so that Li_{1.04}[Ni_{0.48}Mn_{0.29}Co_{0.19}]O₂ was formed as the positive electrode active material. In addition, the average particle diameter of the positive electrode active material was approximately 13 μm.

### Example 2

Except that the ratio of the positive electrode active material, the lithium fluoride, the conductive agent, and the binder agent was set to 90:2:5:3 (the rate of the lithium fluoride to the positive electrode active material was set to 2.2 percent by mass), a battery was formed in a manner similar to that in Example 1 of the second example.

Hereinafter, the battery thus formed is called the “battery B2”.

### Example 3

Except that the ratio of the positive electrode active material, the lithium fluoride, the conductive agent, and the binder agent was set to 89:3:5:3 (the rate of the lithium fluoride to the positive electrode active material was set to 3.4 percent by mass), a battery was formed in a manner similar to that in Example 1 of the second example.

Hereinafter, the battery thus formed is called the “battery B3”.

### Example 4

Except that sodium fluoride was added in the positive electrode formation instead of using lithium fluoride, a battery was formed in a manner similar to that in Example 1 of the second example.

Hereinafter, the battery thus formed is called the “battery B4”.

### Example 5

Except that lithium chloride was added in the positive electrode formation instead of using lithium fluoride, a battery was formed in a manner similar to that in Example 1 of the second example.

Hereinafter, the battery thus formed is called the “battery B5”.

### Comparative Example

Except that lithium fluoride was not added in the positive electrode formation, a battery was formed in a manner similar to that in Example 1 of the second example.

Hereinafter, the battery thus formed is called the “battery Y”.

### Experiment

As in Experiment of the above first example, the charge and discharge and the temperature rise were performed for the above batteries B1 to B5 and Y to investigate the amounts of heat generation thereof, and the results are shown in Table 2. However, although the amount of heat generation was investigated from 160° C. to 240° C. in Experiment of the first example, in this experiment, the amount of heat generation from 160° C. to 300° C. was investigated (that is, the amount of heat generation was investigated in a higher temperature region). In addition, the amount of heat generation of each battery is shown by the index based on the assumption in which the amount of heat generation of the battery Y is 100.

TABLE 2

| | | | | Amount of |
|---|---|---|---|---|
| | Positive Electrode Active | Positive Electrode | Electrolyte | Heat |
| Battery | Material | Additive (Ratio) | Additive | Generation |
| B1 | Li_{1.04}[Ni_{0.48}Mn_{0.29}Co_{0.19}]O₂ | Lithium fluoride | LiBOB | 95 |
| | | (1.1 percent by mass) | | |
| B2 | | Lithium fluoride | | 94 |
| | | (2.2 percent by mass) | | |
| B3 | | Lithium fluoride | | 94 |
| | | (3.4 percent by mass) | | |
| B4 | | Sodium fluoride | | 95 |
| | | (1.1 percent by mass) | | |
| B5 | | Lithium chloride | | 85 |
| | | (1.1 percent by mass) | | |
| Y | | None | | 100 |

As apparent from the above Table 2, even in comparison of the amount of heat generation in a higher temperature region, in the battery B1 in which lithium fluoride was added to the positive electrode, the amount of heat generation was decreased as compared to that of the battery Y in which lithium fluoride was not added to the positive electrode, and hence, it was found that the heat stability was improved. In addition, in the batteries B2 and B3 in which the rates of lithium fluoride to the positive electrode were increased to 2.2 and 3.4 percent by mass, respectively, an effect similar to that described above was also confirmed. However, since the positive electrode capacity is decreased when the rate of lithium fluoride to the positive electrode active material is excessively high, the rate is preferably set to 5 percent by mass or less.

In addition, even in the batteries B4 and B5 in which sodium fluoride and lithium chloride were added to the positive electrodes, respectively, the amount of heat generation was decreased as compared to that of the battery Y, and hence, it was found that the heat stability was improved. Accordingly, it is found that as a substance to be added to the positive electrode, besides lithium fluoride, when an alkali metal halide, such as sodium fluoride or lithium chloride, is used, the heat stability is improved. Although the reason for this has not been clearly understood, when LiPF₆ functioning as an electrolyte salt is decomposed into LiF and PF₅ by heat, in the positive electrode containing an alkali metal halide, such as lithium fluoride, sodium fluoride, or lithium chloride, LiF is likely to precipitate on the surface of the positive electrode active material. Hence, the surface of the positive electrode active material is covered with LiF, and the contact between the transition metal in the positive electrode active material and the nonaqueous electrolyte can be prevented. As a result, it is believed that since the oxidation of the nonaqueous electrolyte is suppressed, the amount of heat generation is decreased.

In addition, in the battery B5 in which lithium chloride was added to the positive electrode, the decrease in amount of heat generation was particularly significant. Although the reason for this has not been clearly understood, it is believed that when lithium chloride is added, besides the precipitation of LiF caused by the above-described decomposition of LiPF₆, the following reaction occurs. That is, although HF is generated when LiPF₆ reacts with H₂O generated in a combustion process, when lithium chloride is present, HF and LiCl reacts with each other to form LiF. Accordingly, it is believed that since LiF is more likely to precipitate on the surface of the positive electrode active material, the surface of the positive electrode active material is further covered with LiF.

### Third Example

### Example 1

Except that magnesium chloride was added in the positive electrode formation instead of using lithium fluoride, a battery was formed in a manner similar to that in Example 1 of the second example.

Hereinafter, the battery thus formed is called the “battery C1”.

### Example 2

Except that calcium fluoride was added in the positive electrode formation instead of using lithium fluoride, a battery was formed in a manner similar to that in Example 1 of the second example.

Hereinafter, the battery thus formed is called the “battery C2”.

### Example 3

Except that calcium chloride was added in the positive electrode formation instead of using lithium fluoride, a battery was formed in a manner similar to that in Example 1 of the second example.

Hereinafter, the battery thus formed is called the “battery C3”.

### Example 4

Except that zirconium fluoride was added in the positive electrode formation instead of using lithium fluoride, a battery was formed in a manner similar to that in Example 1 of the second example.

Hereinafter, the battery thus formed is called the “battery C4”.

### Comparative Example

A battery was formed in a manner similar to that in Comparative Example of the second example.

Hereinafter, the battery thus formed is called the “battery Y”.

### Experiment

As in Experiment of the above first example, after the charge and discharge and the temperature rise of each of the batteries C1 to C4 and Y were performed, the peak height of the main heat generation peak, that is, the amount of heat generation (peak intensity of heat generation) at a temperature at which the heat generation caused by a reaction between the positive electrode and the electrolyte was particularly significant, was investigated, and the results are shown in Table 3. In addition, the peak intensity of heat generation of each of the batteries C1 to C4 is shown by the index based on the assumption in which the peak intensity of heat generation of the battery Y is 100. In addition, in Table 3, the peak intensity of heat generation of each of the above batteries B1, B4, and B5 is also shown.

TABLE 3

| | | | | Peak |
|---|---|---|---|---|
| | | | | Intensity of |
| | Positive Electrode Active | Positive Electrode | Electrolyte | Heat |
| Battery | Material | Additive (Ratio) | Additive | Generation |
| B1 | Li_{1.04}[Ni_{0.48}Mn_{0.29}Co_{0.19}]O₂ | Lithium fluoride | LiBOB | 94 |
| | | (1.1 percent by mass) | | |
| B4 | | Sodium fluoride | | 92 |
| | | (1.1 percent by mass) | | |
| B5 | | Lithium chloride | | 65 |
| | | (1.1 percent by mass) | | |
| C1 | | Magnesium chloride | | 50 |
| | | (1.1 percent by mass) | | |
| C2 | | Calcium fluoride | | 92 |
| | | (1.1 percent by mass) | | |
| C3 | | Calcium chloride | | 62 |
| | | (1.1 percent by mass) | | |
| C4 | | Zirconium fluoride | | 95 |
| | | (1.1 percent by mass) | | |
| Y | | None | | 100 |

As apparent from the above Table 3, besides the batteries B1, B4, and B5 in which lithium fluoride, sodium fluoride, and lithium chloride were added to the positive electrodes, respectively, even in the batteries C1 to C4 in which magnesium chloride, calcium fluoride, calcium chloride, and zirconium fluoride were added to the positive electrodes, respectively, the peak intensity of heat generation was decreased as compared to that of the battery Y, and hence, it was found that the heat stability was improved. Accordingly, as a substance to be added to the positive electrode, besides the alkali metal halides, such as lithium fluoride, sodium fluoride, and lithium chloride, when a metal halide, such as magnesium chloride, calcium fluoride, calcium chloride, or zirconium fluoride is used, it is found that the heat stability is improved. Although the reason for this has not been clearly understood, when LiPF₆ functioning as an electrolyte salt is decomposed into LiF and PF₅ by heat, in the positive electrode containing a metal halide, such as magnesium chloride, calcium fluoride, calcium chloride, or zirconium fluoride, LiF is likely to precipitate on the surface of the positive electrode active material. Hence, the surface of the positive electrode active material is covered with LiF, and the contact between the transition metal in the positive electrode active material and the nonaqueous electrolyte is prevented. As a result, it is believed that since the oxidation of the nonaqueous electrolyte is suppressed, the amount of heat generation is decreased.

In addition, in the batteries C1 and C3 in each of which the chloride was added to the positive electrode, the decrease in peak intensity of heat generation was particularly significant. Although the reason for this has not been clearly understood, it is believed that when the chloride is added, besides the precipitation of LiF caused by the decomposition of LiPF₆ described above, the following reaction occurs. That is, although HF is generated when LiPF₆ reacts with H₂O generated in a combustion process, when the chloride is present, 2HF reacts with MgCl₂ or CaCl₂ to generate MgF₂ or CaF₂, respectively, and the fluoride thus generated precipitates on the surface of the positive electrode active material as is the above LiF and covers the positive electrode active material. Hence, the contact between the transition metal in the positive electrode active material and the nonaqueous electrolyte can be further suppressed. As a result, it is believed that since the oxidation of the nonaqueous electrolyte is further suppressed, the amount of heat generation is further decreased.

### Reference Example

### Reference Example 1

Except that lithium fluoride was not added in the positive electrode formation, and LiCoO₂ was used as the positive electrode active material, a battery was formed in a manner similar to that in Example of the first example. In addition, in the positive electrode formation, the ratio of the positive electrode active material, the conductive agent, and the binder agent was set to 92:5:3 on a mass ratio.

Hereinafter, the battery thus formed is called the “battery R1”.

### Reference Example 2

Except that LiCoO₂ was used as the positive electrode active material, a battery was formed in a manner as that in Example of the first example.

Hereinafter, the battery thus formed is called the “battery R2”.

### Experiment

As in Experiment of the above first example, after the charge and discharge and the temperature rise were performed for the batteries R1 and R2, the amount of heat generation from 160° C. to 240° C. was investigated, and the results are shown in Table 4. In addition, the amount of heat generation of the battery R2 is shown by the index based on the assumption in which the amount of heat generation of the battery R1 is 100.

TABLE 4

| | Positive | Positive | | Amount |
|---|---|---|---|---|
| | Electrode | Electrode | Electrolyte | of Heat |
| Battery | Active Material | Additive | Additive | Generation |
| R1 | LiCoO₂ | None | LiBOB | 100 |
| R2 | | lithium fluoride | | 98 |

As apparent from Table 4, when the battery R2 in which lithium fluoride was added to the positive electrode was compared to the battery R1 in which lithium fluoride was not added to the positive electrode, it was found that the amount of heat generation was not changed so much from each other. The reason for this is that although the oxidation of the nonaqueous electrolyte is advanced on a lithium transition metal oxide containing nickel by a catalytic action thereof, the oxidation of the nonaqueous electrolyte caused by a catalytic action of LiCoO₂ is hard to be extremely caused. Hence, it is believed that even when the contact between the positive electrode active material and the nonaqueous electrolyte is prevented by covering the surface of the positive electrode active material with lithium fluoride, the suppression in oxidation thereby has not significant meaning.

In addition, when LiNiO₂ is used as the positive electrode active material, the heat stability thereof is extremely low. Accordingly, compared to the oxidation of the nonaqueous electrolyte on the surface of the positive electrode active material caused by a catalytic action thereof, the oxidation of the nonaqueous electrolyte caused by oxidation desorption from the positive electrode active material is significantly dominant. Hence, even if the surface of the positive electrode active material is covered with lithium fluoride, the oxidation of the nonaqueous electrolyte cannot be suppressed, and hence the heat generation cannot be suppressed.

### INDUSTRIAL APPLICABILITY

The present invention relates to a drive power source for a mobile phone, a notebook personal computer, a mobile information terminal, such as PDA, or the like and may be applied to application in which a high capacity is particularly required. In addition, in a high-output application in which continuous drive is required at a high temperature, the present invention is also expected to be widely used for application, such as an electric automobile or an electric power tool, in which a battery is to be used under a severe operation environment.

1-7. (canceled)

8. A nonaqueous electrolyte secondary battery comprising:
a positive electrode including a metal halide and a positive electrode active material containing a lithium transition metal oxide which includes nickel and manganese;
a negative electrode including a negative electrode active material; and
a nonaqueous electrolyte including a nonaqueous solvent, a fluorine-containing lithium salt, and a lithium salt which comprises an oxalate complex as an anion.

9. The nonaqueous electrolyte secondary battery according to claim 8,
wherein the lithium transition metal oxide has the formula Li₁₊ₓNiₐMn_{b}Co_{c}O_{2+d}, wherein x, a, b, c, and d satisfy x+a+b+c=1, 0.7≦a+b, 0<x≦0.1, 0≦c/(a+b)<0.65, 0.7≦a/b≦2.0, and −0.1≦d≦0.1, and the lithium transition metal oxide has a layered structure.

10. The nonaqueous electrolyte secondary battery according to claim 8,
wherein the lithium salt which comprises an oxalate complex as an anion comprises a lithium bisoxalate borate, and the concentration thereof to the nonaqueous solvent is in a range of 0.05 to 0.3 mol/liter.

11. The nonaqueous electrolyte secondary battery according to claim 8,
wherein a halogen of the metal halide comprises at least one halogen selected from the group consisting of fluorine and chlorine.

12. The nonaqueous electrolyte secondary battery according to claim 8,
wherein a metal of the metal halide comprises at least one metal selected from the group consisting of Li, Na, Mg, Ca and Zr.

13. The nonaqueous electrolyte secondary battery according to claim 11,
wherein the metal halide comprises at least metal halide selected from the group consisting of LiF, NaF, CaF₂, ZrF₄, LiCl, CaCl₂, and MgCl₂.

14. The nonaqueous electrolyte secondary battery according to claim 8,
wherein the rate of the metal halide to the positive electrode active material is in a range of 0.1 to 5.0 percent by mass.
